(19) United States
(12) Patent Application Publication
(10) Pub. No.: US 2015/0102144 A1
(43) Pub. Date: Apr. 16, 2015

(54) Apparatus With Variable Scale For Treating Particulate Material

(71) Applicant: Herbert Huettlin, Steinen (DE)

(72) Inventor: Herbert Huettlin, Steinen (DE)

(21) Appl. No.: 14/576,984

(22) Filed: Dec. 19, 2014

Related U.S. Application Data
(63) Continuation of application No. PCT/EP2012/061833, filed on Jun. 20, 2012.

(51) Int. Cl. B01J 2/16

(52) U.S. Cl. CPC B01J 2/16
USPC 241/39

(57) ABSTRACT

An apparatus for treating particulate material, including a process chamber which has a bottom constructed from overlapping guide plates between which there are gaps present through which process air can be introduced approximately horizontally into the process chamber, wherein the guide plates are arranged such that two flows of process air, which are oppositely directed one towards the other and meet along a breaking up zone, are formed, wherein in the breaking up zone a treatment medium can be sprayed onto the material via at least one linear spray nozzle. The apparatus is composed of individual performance modules of approximately same construction type and size, wherein the performance modules have a rectangular cross section and can be joined together via at least one open rectangle side to form a row, the longitudinal extents of the respective breaking up zones extend in the direction of the row.

### FIELD OF THE INVENTION

The invention relates to an apparatus for treating particulate material, comprising a process chamber which has a bottom constructed from overlapping guide plates between which there are gaps present through which process air can be introduced approximately horizontally into the process chamber, wherein the guide plates are arranged such that two opposite flows of process air, which are directed one towards the other and meet along a breaking up zone, are formed, wherein in the breaking up zone a treatment medium can be sprayed onto the material via at least one spray nozzle.

### BACKGROUND OF THE INVENTION

An apparatus of this type is known from DE 199 04 147 A1.

A bottom of the process chamber, which bottom is of circular cross section, consists of mutually overlapping, approximately flat guide plates, between which are formed gaps or slots via which process air having a substantially horizontal motion component can be introduced into the process chamber. The slots are here arranged in such a way that two opposite flows of introduced process air, which are directed one towards the other and run substantially horizontally, are formed, which flows collide along a breaking up zone and are diverted into a flow directed substantially vertically upwards. The particles to be treated are correspondingly transported by the process air and, after having reached a certain height, drop due to gravity to the left and right away from the breaking up zone back down onto the bottom. There they are moved again by the process air in the direction of the breaking up zone. In the breaking up zone, spray nozzles are provided in order to apply to the material moved vertically upwards in the breaking up zone a spraying medium, for instance a coating solution. The process air has a certain heat content which ensures a soonest possible drying process on the surface of the sprayed material particle, so that this, if it drops down again and is again moved towards the breaking up zone, is already dried off as far as possible. In the next cycle, a layer of treatment medium is then sprayed on again, so that a very uniform and, in particular, very dimensionally stable coating layer can gradually be applied.

In a refinement of the technology comprising the breaking up zones, bottom designs in which the breaking up zone runs circularly have been developed. If also a circumferential motion component is imposed upon the incoming process air, floating, rotating product rings, in which the individual product particles are circulated toroidally, are formed in the process chamber.

Given a specific size of appliance and for a certain band width of material particles, this enables superb treatment results to be obtained. With appliances of this kind, in particular material particles >1.5 mm and to within the centimetre range, i.e. in the order of magnitude of tablets or oblong-shaped capsules, can be treated.

In such appliances, the so-called “scaling-up” poses a problem. Therefore, first tests with a material to be treated are conducted initially in small appliances, in which case batch sizes in the region of up to approximately 300 g are customary.

After this, work is performed in larger appliances on a so-called laboratory scale, with batch sizes up to in the region of a few kilograms. If satisfactory results are obtained there, then a step further is taken into the so-called pilot scale, in which, in once again larger appliances, batch sizes in the region of up to 100 kg can be treated.

Depending on the type of the material to be treated, plants which allow batch sizes up to in the region of 1,000 kg are then created on a production scale.

In a number of technical fields, in particular in the pharmaceutical sector, not only, however, do the batch sizes change from product to product, but also the size and shape of the material to be treated changes.

A major role is also played by the substance from which the material is made, for instance whether it exhibits good flow properties, whether it has sufficient strength, or whether it is prone to chippings and flaking, which is often the case with compressed tablets prior to coating.

It is then necessary to find for each batch size and for specific material properties, in lengthy studies and numerous trials, optimally tailored appliance sizes for the realization of the treatment.

Tunnel-shaped apparatuses for treating particulate material, which have an elongated process chamber along which the material to be treated is movable from an inlet to an outlet, are known from DE 103 09 989 A1. However, this apparatus has a quite specific size or length, which is encumbered with corresponding investment costs and a corresponding spatial requirement. As a result of the non-stop continuous operation, it is possible, in the case of inherently consistent material, to adapt to different batch sizes by operating the plant in continuous flow for a correspondingly longer or shorter time.

### SUMMARY OF THE INVENTION

It is an object of the present invention is to provide an apparatus which is intrinsically suitable for treating a relatively large spectrum of different materials having different properties, yet which, at the same time, is flexibly adaptable to different batch sizes without the need to create voluminous appliances which in principle are designed for much larger batch sizes.

Apparatus for treating a particulate material, said apparatus being composed of joined individual performance modules, each of said performance modules being of approximately same construction type and same size, each of said performance modules comprises a housing having a horizontal rectangular cross section with upstanding side wall parts, each performance module being able to be joined to another performance module via at least one open side wall part, each of said individual performance modules comprise a process chamber having a bottom constructed from overlapping guide plates, between which gaps are present through which a process air can be introduced approximately horizontally into said process chamber, said overlapping guide plates being arranged in that two flows of said process air of opposite flowing direction can be formed when process air being introduced, said two opposite flows of said process air meet along a linear breaking up zone and are deflected upwardly in said process chamber, at least one spray nozzle being arranged in said breaking up zone for spraying a treatment medium onto a material moving upwardly in said breaking up zone, wherein said individual performance modules are joined together to a row in an orientation that said longitudinal breaking up zones of said bottoms of said joined performance modules extend in a same direction and in a direction of said row.

The term performance module in the sense of the present invention means that this performance module, having the design specifications of a bottom comprising overlapping guide plates and of the breaking up zone, is capable of superbly treating a relatively large spectrum of different material particles exhibiting different properties up to a specific batch size. Such experiences are familiar to the Applicant, for instance, in connection with the appliances mentioned in the introduction, having a round cross section and the breaking up zone. In other words, such a performance module of this construction type and of a specific size “performs” optimal fluidization and movement of a material, and this in respect of a quite specific bulk height in the process chamber. Such a performance module can treat, for example, material particles of very diverse shape, size and density, inter alia also solid compacts from the field of pharmacy, chemical engineering, the food sector or the confectionery sector. In the food industry, these are granular materials such as coffee beans or the like, in the confectionery industry sweets or chocolate drops.

The provision of an approximately rectangular cross section enables very flexible adaptation to the requirements of different customers by virtue of the fact that individual performance modules can be joined together via an open rectangle side to form a row, wherein the longitudinal extents of the respective breaking up zone extend and join together in the direction of the row.

In the simplest case, two such performance modules are combined into an apparatus via a respectively open side. In each individual performance module, the treatment characteristic remains approximately the same, so that batch sizes in the factor of 2 can be worked without complex design modifications.

If three such performance modules are combined, then the middle one has two opposite open sides, to which a performance module provided with an open side is respectively attached.

Accordingly, four, five, six or more such performance modules can also be lined up together along the row.

The process air guidance, and thus also the temperature and moisture control, as well as the filling and emptying characteristic, can in principle remain unchanged, as long as, simply, an appropriate number of performance modules are lined up together. It has been established in numerous trials that, where there are a large number of different product characteristics and sizes, the alignment of a plurality of performance modules yields a consistently good treatment result with increasing batch size.

A modular system containing a plurality of performance modules hence enables a scaling-up to be flexibly realized without great alteration of the flow/motion characteristic, in order thus to ensure a consistent treatment result with different batch sizes.

In a further embodiment of the invention, a partition can be inserted between two adjacent performance modules, which partition splits the joined-together performance modules into sub-units of performance modules.

This embodiment now increases the flexibility of such an apparatus such that not only is a scaling-up easily possible, but also correspondingly smaller batches can easily be processed.

If the simplest example involving the coupling of two performance modules is assumed, the simple insertion of just one partition, or respectively in one of the two performance modules, enables a treatment to be carried out when a correspondingly smaller batch size is intended to be processed.

In the case of three combined modules, such a partition can be inserted, for instance, between the first and second performance module. As a result of this simple measure, an apparatus is available for three different batch sizes, namely the batch sizes which can be treated by three performance modules at once, batch sizes which can optimally be treated by two performance modules, or batch sizes which can optimally be treated by a single performance module. This demonstrates particularly impressively the flexibility of the plant, not only in terms of a scaling-up, but also a scaling-down.

The interposition of a partition is an easily implementable measure which can also be realized by simple means, by the mere insertion of a wall between the joined-together performance modules, for instance from above or from the side.

In a further embodiment of the invention, each performance module has an own blower, by which the process air can be introduced into the process chamber through the bottom.

This measure has the advantage that the process air guidance through the process chamber of a performance module is respectively individually or optimally adjustable.

In a further embodiment, the blower is constructed as an axial-flow blower, the fan of which is arranged beneath the bottom in the performance module.

This advantageously opens up the possibility of a direct control and low-loss supply of the process air to the underside of the bottom.

In a further embodiment of the invention, each performance module, on a side offset by 90° from the open side, is provided with a filter arrangement.

This measure has the advantage that, in a performance module itself, material particles, or chippings thereof, entrained by the process air can be detained and, if need be, fed back to a treatment process.

In a further embodiment of the invention, each performance module is provided with a movable lid, which constitutes an upper extremity of the process chamber.

This measure has the advantage that the lid enables the process chamber to be opened, so that appropriate manipulations, such as filling, cleaning or the like, can be performed through this opening. If the lid is made of glass, the course of treatment in the process chamber can be visually observed through this lid.

In a further embodiment of the invention, process air flowing off from the process chamber is diverted by the lid, in a laterally and downwardly directed passage, into the filter arrangement.

This measure has the advantage that the lid additionally serves both as a diversion mechanism and to guide the process air to the filter arrangement.

In a further embodiment of the invention, under the bottom there is arranged at least one heat exchanger.

This measure has the advantage that, via the heat exchangers, a low-loss and effective temperature control can be effected.

Thus a heat exchanger can be configured as a type of cold trap in order to condensate out moisture entrained by the process air. The heat exchanger can also be employed to bring the process air which is fed by the blower to the underside of the bottom rapidly to an optimal temperature.

In a further embodiment of the invention, in the breaking up zone, at least in sections, is arranged a linear spray nozzle, which sprays vertically upwards.

This measure has the advantage that such a nozzle configuration in the breaking up zone enables the upwardly diverted material to be sprayed with the treatment medium at a favourable place, over a certain length. Following the ascent in the breaking up zone, the particles drop down again on both sides of the breaking up zone, so that sufficient space and time is available to let the medium sprayed on in the breaking up zone dry off.

In a further embodiment, at least one wall can be introduced into a performance module, which wall(s) divide(s) the process chamber of this particular performance module into at least two sub-process chambers.

This measure has the considerable advantage that a performance module can be divided by this wall into smaller sub-units in order, for instance, to conduct first trials with a certain material on a miniature or laboratory scale.

Expediently, a performance module is of such a size that within it can be treated a specific batch which frequently appears in this sector in which the performance module is used. Should a novel material be treated, division of the process chamber of a performance module into at least two sub-units enables appropriate trials to be conducted on a miniature or laboratory scale. If a performance module has the capability, for instance, of working a material of approximately 30 bulk litres, then this, depending on how the wall is inserted, can be divided into two sub-units of 15 bulk litres each, or into two sub-units of 10 and 20 bulk litres respectively. It is not then necessary, besides the smallest performance module unit, to provide still smaller units in order to conduct such laboratory trials. Expediently, this option will then be provided in respect of a performance module at the end or at the start of a row of joined-together performance modules. This demonstrates particularly impressively the flexibility of the apparatus with respect to batch sizes.

In a further embodiment of the invention, the linear spray nozzle is divided into individual portions in order to supply the sub-process chamber formed by the inserted wall with spraying medium.

This measure has the advantage that, in connection with the provision of sub-process chamber, the linear spray nozzle is also divided accordingly, so that the respective sub-units can then variably be supplied with spraying medium by means of a portion of the linear spray nozzle.

In a further embodiment of the invention, two performance modules are combined to a double performance module, said two performance modules are combined along open side wall parts thereof which are 90° offset to said at least one open side wall part for joining to a next performance module of said row.

This measure has the advantage that, in addition to the joining along the row, initially two performance modules can be combined, transversely to the direction of this joining, into a double performance module. These double performance modules can then be put together, so that then a row is formed, the capacity of which is already initially twice as large as that of a single performance module.

In other words, a scaling-up takes place not in steps 1, 2, 3, 4, 5 of aligned performance modules, but in steps 2, 4, 6, 8, 10, etc.

In a further embodiment, each of said two performance modules are provided with a filter arrangement arranged on one side wall part thereof, said filter arrangements are arranged on opposite side wall parts of the resulting double performance module, said opposite side wall parts extend transversely to said direction of said row.

This measure has the advantage that, when a plurality of such double performance modules are lined up together along the row, the filter arrangements are located respectively along the outer side of the formed elongated rectangular body and are thus easily accessible for changeover operations.

In a further embodiment of the invention, a performance module has a process chamber of approximately square cross section, in which the breaking up zone runs centrally.

This geometry has the advantage that to the left and right of the breaking up zone there is an equal space available to the falling material, which is conducive to a uniform treatment result.

In further embodiments, the process chamber has a cross-sectional width within the size range from 300 to 700 mm, in particular within the range from 400 to 600 mm, and most preferably a width of approximately 500 mm.

Parallelly thereto, it is advantageous if the process chamber has a static product fill height within the range from 100 to 150 mm, from approximately 110 to 140 mm, and most preferably in the region of approximately 135 mm.

Numerous trials with material particles which are provided for treatment in the various sectors and which range in size from 1.5 mm into the centimetre range have shown that these can be treated very well and very uniformly in process chambers within this cross-sectional range. A single performance module already shows a relatively large flexibility with respect to different material particles, in particular having different sizes and different flow properties of material particles. In the case of one performance module, that is about 33.5 bulk litres. In a row arrangement of three individual performance modules, approximately 100 kg, in the case of six performance modules about 200 kg batch sizes are possible. If double performance modules have been operated from the outset, the batch size increases correspondingly. Through insertion of the appropriate rapidly changeable partition in the grid dimension of the longitudinal extent of a performance module, for instance of 500 mm, batch sizes constituting a multiple of a “basic bulk quantity”, of, for instance, 33.5 bulk litres, of an individual performance module can then be variably worked.

In a further embodiment of the invention, the linear spray nozzle has spray-active longitudinal portions of 50 to 100 mm.

It has been established in trials that active spraying length portions of this kind are sufficient to be able to obtain optimal treatment results in a performance module.

Short portions also open up the possibility of producing in a performance module, through the insertion of walls, the appropriate sub-units in a basic performance module, which can then be supplied with spraying medium by the individual short portions.

In a further embodiment of the invention, in the bottom are arranged air guide elements, which impose upon the process air flowing through the bottom a motion component in the direction of the row of joinable performance modules.

This measure has the advantage that, in addition to the main circulating motion directed transversely to the longitudinal extent of the breaking up zone, an additional axial motion component is also imposed, if so desired.

In a further embodiment of the invention, the guide elements are adjustable, so that a variable motion component in the direction of the row can be imposed by these upon the process air.

This measure has the advantage that a very flexible reaction can be made to different material factors.

In a further embodiment of the invention, the guide elements are adjustable in such a way that on one side of a breaking up zone a motion component in one direction of the row can be imposed upon the process air, whilst on the other side of the breaking up zone the motion component can be imposed in the opposite direction.

If the bottom of one or more aligned performance modules of this kind is viewed from above, then, as a result of this embodiment, on one side of the breaking up zone the material moves in a direction along the alignment, for instance from left to right, yet on the opposite side from right to left.

At some point, these moving parts strike an end face wall of an end performance module. Viewed in one direction, material particles are gradually pushed in the direction of this wall and compacted there.

Since, on the opposite side, the motion component is opposite in nature, on the other side of the breaking up zone a paucity of material obtains on this wall.

This leads to a situation in which, from the one side having the material compaction, material particles are moved transversely across the breaking up zone into the impoverished zone and fed to the other half of the material particles.

At the opposite end of the row, the reverse process then takes place, that is to say that the material particles fed to this half are piled up and compacted at the opposite end and then pass over into the other material half via the breaking up zone. If, as previously mentioned, the process is now viewed from above, then it is evident theta circumferential motion component is superimposed, which motion component, depending on the number of performance modules which are linked together, is of more or less elongated rectangular configuration.

This additional motion component once again contributes considerably to a uniform treatment result. A certain approximation to the annular geometry in process chambers of circular cross section is given, wherein no exact annular geometry, but rather a correspondingly circumferential rectangular motion appears, which is superimposed upon the motion directed in the direction of the breaking up zone and upon the vertically upward ascent and the redescent of the material particles. Viewed overall, the motion resulting therefrom is very conducive to a better treatment result.

In a further embodiment of the invention, the guide elements are configured as guide fingers arranged between the guide plates and pivotable about a vertical axis, which guide fingers are connected to a common actuating element, the displacement of which produces a joint pivoting of the guide fingers.

It is thereby possible, as a result of the countless guide fingers, to additionally impose desired motion components upon the process air, wherein, as a result of the common actuating element, this displacement runs in each case synchronously.

In a further embodiment of the invention, the guide elements on one side of the breaking up zone are adjustable independently from the guide elements of the opposite side.

This measure has the advantage that numerous processes for influencing the process air are thereby possible. If the guide elements are adjusted such that the previously described opposing flows, viewed in the direction of joining, are formed, then the previously described “circulation” results.

It is also possible, however, to orient the guide elements exactly such that the material particles shall be moved virtually at right angles up to the breaking up zone, if so desired. This also opens up the possibility of orienting the guide elements all in the same direction, so that the entire material is gradually moved from one end of the apparatus to the other. That opens up the possibility of making the joined-together performance modules work either in continuous operation, or, at the end of a treatment process, of orienting the guide elements such that an emptying in one direction is thereby possible. This too demonstrates the highly flexible design for adaptation to different material properties, in this case, in particular, flow properties.

In a further embodiment of the invention, the control mechanism for the adjustability of the guide elements is configured such that, when adjacent performance modules are lined up together, the control mechanisms can be coupled to one another.

This measure has the advantage that, in the course of the joining together, the control mechanisms are coupled by virtue of appropriate coupling features, so that the desired orientation of the guide elements, when a plurality of performance modules are joined together, can then be realized exactly synchronously by the coupling.

Self-evidently, the above-stated features and the features yet to be explained below are usable not only in the respectively stated combination, but also in other combinations or in isolation, without departing from the scope of the present invention.

### BRIEF DESCRIPTION OF THE DRAWINGS

The invention is described and explained in greater detail below with reference to the appended drawings in connection with some selected illustrated embodiments, wherein:

FIG. 1 shows a vertical section of a performance module;

FIG. 2 shows the vertical section of FIG. 1 with flow arrows for illustration of the moving media and material particles in such a performance module;

FIG. 3 shows a section along the line in FIG. 1;

FIGS. 4a to 4d
show sections corresponding to FIG. 3 with a different number of performance modules joined together along a direction of an alignment, namely two, four and six;

FIG. 5 shows a section, corresponding to the representation of FIG. 3, of a row of performance modules, as represented in FIG. 1, wherein at the upper end sections along the lines Va, Vb and Vc of FIG. 1 are represented;

FIG. 6 shows a heavily schematized top view of a performance module of FIG. 1, wherein the motional direction of the material particles in a performance module is shown;

FIG. 7 shows a representation, corresponding to FIG. 6, having two joined-together performance modules;

FIG. 8 shows a detail in vertical section of a bottom of a performance module;

FIG. 9 shows a partially open top view of guide elements which are arranged in the bottom;

FIG. 10 shows a partially opened-up top view of a multiplicity of guide elements in a specific adjustment state;

FIG. 11 shows a top view, corresponding to the top view of FIG. 10, with differently adjusted guide elements;

FIG. 12 shows a perspective, partial view of an apparatus having six performance modules;

FIG. 12a shows a detail from FIG. 12;

FIG. 13 shows the apparatus of FIG. 12 in the finished state;

FIG. 14 shows a vertical sectional representation, comparable to the representation of FIG. 1, of a double performance module composed of two performance modules of FIG. 1

FIG. 15 shows a top view, corresponding to the representation of FIG. 3, of a row of six joined-together double performance modules.

### DETAILED DESCRIPTION OF THE INVENTION

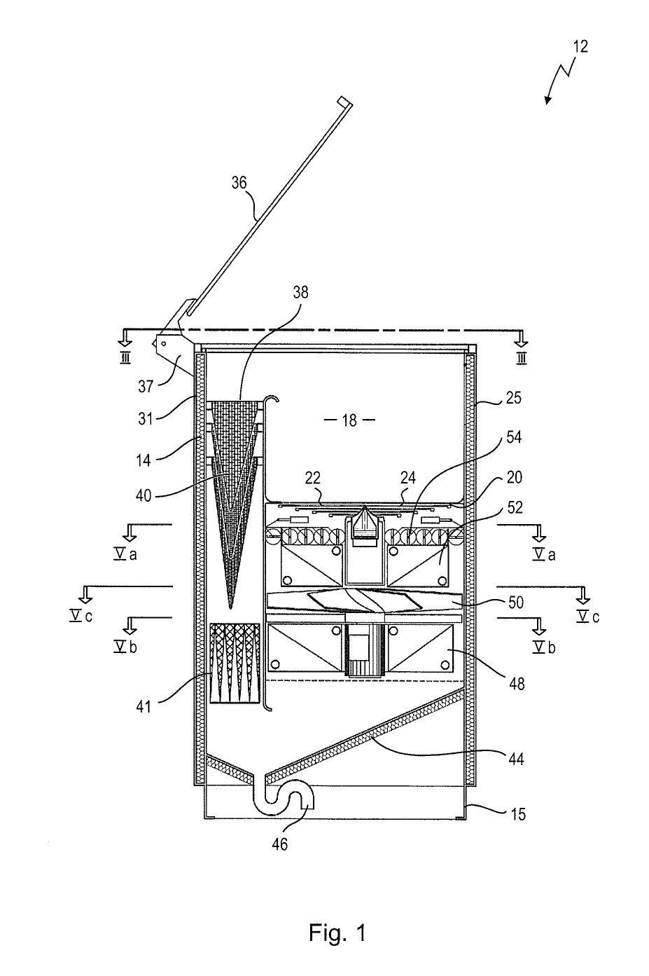

In FIGS. 1 to 13 is represented a first illustrative embodiment of an apparatus according to the invention, which is denoted in its entirety by the reference numeral 10.

The apparatus 10 is composed of individual performance modules 12, wherein firstly the structure of a single performance module 12, as is represented in FIGS. 1 to 4a, shall be described for the purpose of basic understanding.

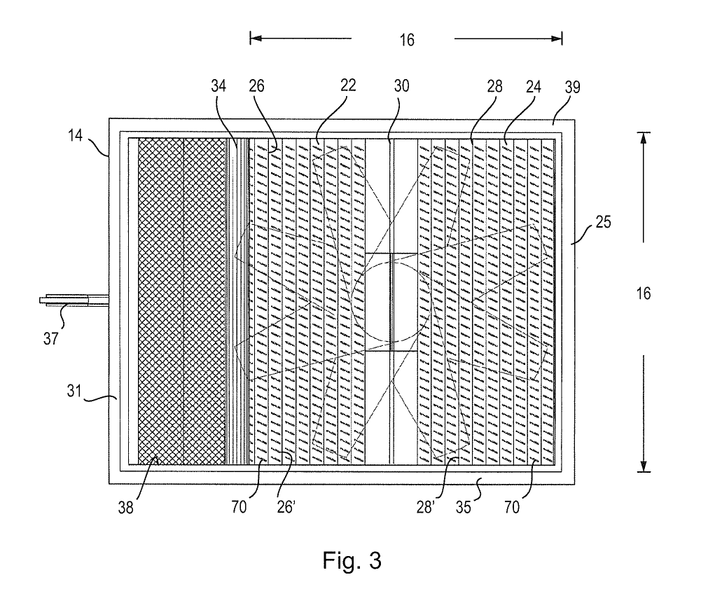

Each performance module 12 has a double-walled, insulated housing 14 made of special steel plate. The housing 14 has four upstanding side wall parts, i.e. a face wall 25, a rear wall 31 and two side walls 35 and 39. The cross section 16 of housing 14, as is shown in FIG. 3, is approximately rectangular. The longer rectangle side has a length of approximately 700 mm, the shorter one a length of approximately 500 mm.

The height of the housing 14 is approximately 1,300 mm.

The housing 14 is closed off at the lower end by a base 15. At the upper end, the housing 14 is open and is covered by a lid 36 made of transparent industrial glass. The lid 36 is attached via a mounting 37 to the rear wall 31 of the housing 14, such that it can be swung open.

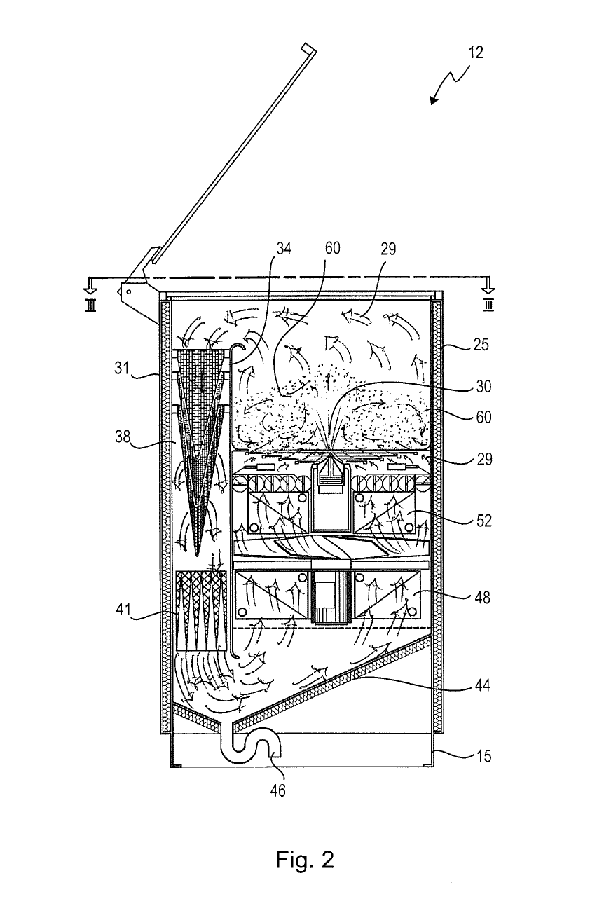

Present inside the housing 14 is a process chamber 18, the cross-sectional measurement 16 of which, as can be seen in particular from FIG. 3, is square and has the measurements 500 mm×500 mm. At the lower end, the process chamber 18 is provided with a bottom 20, which is composed of two rows of partially overlapping series of guide plates 22 and guide plates 24 placed one above the other. In particular from the top view of FIG. 3, it can be seen that the series of guide plates 22 is formed of a row of partially overlapping sheet metal strips placed one above the other, so that between a higher situated strip and an underlying strip are respectively formed gaps 26, 26′, through which process air 29 can pass, as is indicated in FIG. 2. Correspondingly, gaps 28, 28′ are present between the guide plates 24.

As is evident in particular from FIG. 3, the gaps 26 extend parallel to the, in this top view, right-hand face wall 25 of the housing 14. This is the wall which lies opposite the wall to which the mounting 37 for the lid 36 is attached.

This face wall 25 extends between the two side walls 35 and 39.

As is evident in particular from the sectional representations of FIGS. 1 to 3, the process chamber 18 is delimited on one side by a chamber wall 34. The chamber wall 34 extends over the full width between the side walls 35 and 39.

As can be seen in particular from the sectional representation of FIGS. 1 and 2, the chamber wall 34, viewed from the bottom 20, extends over a certain height, in this case of approximately 300 mm, yet ends at a distance before the upper end of the housing 14. At the upper end, the chamber wall 34 is rounded.

The chamber wall 34 borders inside the hosing 14 a function chamber 38.

The function chamber 38 thus extends next to the actual process chamber 18 and is laterally bounded by parts of the side walls 35 and 39, inside the housing 14 by the chamber wall 34, and at the rear, or in the representation of FIGS. 2 and 3, left-hand end by the rear wall 31.

As is evident in particular from the sectional representations of FIGS. 1 and 2, the function chamber 38a accommodates a filter arrangement. This is in the form of three V-shaped coarse dust filters 40 placed one inside the other, so-called filter stages 1 to 3, having downwardly decreasing finer pores.

Beneath the three V-shaped coarse dust filters 40 is further arranged a so-called pocket microfilter stage 41.

Extending under the function chamber 38 is a condensate collecting trough 44 of V-shaped cross section, which is provided with a condensate drain 46.

In the region of the process chamber 18, yet beneath the bottom 20 and approximately directly above the trough 44, is arranged a low-temperature cooler 48. The low-temperature cooler 48 is designed such that it can fall below the dew point of the process air 29, so that water or solvent entrained by the process air 29 through the filter arrangement can condensate out and drip down. These liquid quantities are collected by the trough 44 and fed to the condensate drain 46, via which these condensates can be led off from the apparatus 10.

Above the low-temperature cooler 48 is arranged a high-power axial-flow blower 50, which is designed to move the process air 29. The said blower can be motor-driven or belt-driven.

At the downstream end, i.e. above the axial-fan blower 50, is arranged a heat exchanger 52, via which the process air 29 conveyed by the axial-flow blower 50 to the underside of the bottom 20 can be appropriately conditioned, that is to say heated.

Between the heat exchanger 52 and the underside of the bottom 20 are further arranged so-called bypass valves 54, which serve for a spontaneous and rapid temperature control of the process air 29.

From the sectional representations, in particular the sectional representations of FIGS. 1, 2 and 3, it is evident that in the bottom 20 is arranged a linear spray nozzle 32, which sprays vertically upwards into the process chamber 18. The linear spray nozzle 32 extends approximately centrally in the cross section 16 of the process chamber 18 and runs parallel to the face wall 25 of the housing. The linear spray nozzle 32 can spray over its entire length, or only in sections. The linear spray nozzle 32 is thus located midway between the first series of guide plates 22 placed one above the other and the opposite, second series of guide plates 24 placed one above the other.

The gaps 26, 26 between the partially overlapping guide plates 22 placed one above the other are oriented such that, as a result of this through-passing process air 29, they are directed, in an approximately horizontal course, at the linear spray nozzle 32.

The gaps 28, 28′ between the second series of guide plates 24 placed one above the other are then directed such that, through these, the process air 29 is likewise directed towards the linear spray nozzle 32.

This produces two opposing, mutually oppositely directed partial flows, which meet in the middle of the region of the linear spray nozzle 32. There the opposing, meeting process air currents are deflected upwards approximately at right angles, as is indicated in FIG. 2. This region is the so-called vertical breaking up zone 30. Since the linear spray nozzle 32 is configured as a vertically upward spraying nozzle, the liquid spraying medium is sprayed in this region onto the moving, at this point ascending material particles 60.

The material particles 60 move upwards on both sides of the breaking up zone 30 and then drop back down again, laterally away from the breaking up zone 30, due to gravity. Also some particles here bang against the inner side of the face wall 25 or collide with the inner side of the chamber wall 34 and are led by this downward again in the direction of the bottom 20. In the region of the bottom 20, the material particles 60 are then taken up again by the process air 29 passing through the gaps 26 and 28, accelerated and moved in the direction of the breaking up zone 30. The falling material particles 60 hereupon drop onto a type of air cushion of the process air 29 which has been introduced approximately horizontally.

As can be seen in particular from FIG. 2, after a certain time the process air 29 separates from the again falling material particles 60 and flows between the bottom side of the lid 36 and the top edge of the chamber wall 34 into the function chamber 38.

There the process air 29 flows from top to bottom firstly through the series of three coarse dust filters 40, in which material particles 60, or fragments thereof, entrained by the process air 29 are filtered out in stages.

After this, the process air 29 further runs through the downstream pocket microfilter stage 41, so that it leaves this microfilter stage 41 virtually free from solids. The process air 29 is then sucked up again by the axial-flow blower 50 and guided upwards past the low-temperature cooler 48.

Liquid quantities present in the process air 29 hereupon condensate out. These are, on the one hand, water, and, above all, solvent constituents which serve to dissolve the treatment medium which is sprayed through the linear spray nozzle 32.

By the axial-flow blower 50, the process air 29 which has been freed of both solid and liquid parts is moved in the direction of the underside of the bottom 20 and accelerated. Via the heat exchanger 52 and the bypass valves 54, the process air 29 is appropriately conditioned.

After having passed through the bottom 20, the process air 29 again ensures that material particles 60 wetted with the spraying medium by the linear spray nozzle 32 are moved upwards, which material particles then drop back down again laterally onto the bottom 20. The design is such that sufficient time and, above all, also space is available to the material particles 60 to allow these to dry and not cake together into agglomerates. The appropriately warm process air 29 hereupon takes up the solvent and then flows off, as previously described, back out of the process chamber 18.

In this case, the performance module 12 thus works, as far as the process air 29 is concerned, in a closed circulation system.

From the outer side, the linear spray nozzle 32 is merely fed the liquid medium to be sprayed, the solid components of which are intended to be applied to the material particles 60 and the liquid components of which are entrained by the process air 29 until this reaches the condenser again.

The performance module 12 is not only a self-contained system with respect to the process air 29, but offers at a specific size, in particular in connection with the previously stated measurements, an apparatus in which a relatively large spectrum of particulate material particles 60 can be treated. The lower limit lies at material particles in the region of approximately 1.5 mm, the upper limit in the centimetre range of tablets or oblong-shaped capsules, as are intended to be coated in particular in the medical sector, or are intended to be provided with a coating layer in the confectionery or food industry. The static product fill height above the bottom 20 is here approximately 135 mm. A batch size per performance module 12 of approximately 33.5 bulk litres is thereby obtained.

In FIGS. 4b to 4d is represented how a plurality of previously described performance modules 12 are combined into a row.

The representation of FIG. 4a corresponds to the representation of FIG. 3, though in this case the performance module 12 is rotated through 90°. From FIG. 4b it can be seen that two such performance modules 12 are combined into a row.

To this end, in the case of the, in the representation of FIG. 4b, left-hand performance module 12, its side wall 39, and in the case of the corresponding right-hand module 12, the side wall 35 has been removed.

This produces a rectangular structure, as is represented in FIG. 4b. The respective linear spray nozzles 32, and thus also the corresponding breaking up zones 30, here lie linearly one behind the other and are lined up correspondingly. It is also evident that the function chambers 38 are lined up on one side next to each other, so that the filters accommodated therein are accessible from one side.

In FIG. 4c, it is now represented how four such performance modules 12 are lined up. Here, in the case of the middle two performance modules 12, the side walls 35 and 39 are then no longer present, so that, viewed overall, a rectangular process chamber is formed, which process chamber has the width of one performance module 12, i.e. approximately 500 mm, yet the length of four performance modules 12. i.e. 2,000 mm.

In FIG. 4d is represented how six such performance modules 12 are lined up. In this case, an elongated rectangular process chamber has thus been obtained, the length of which is 3 m and the width of which is 0.5 m.

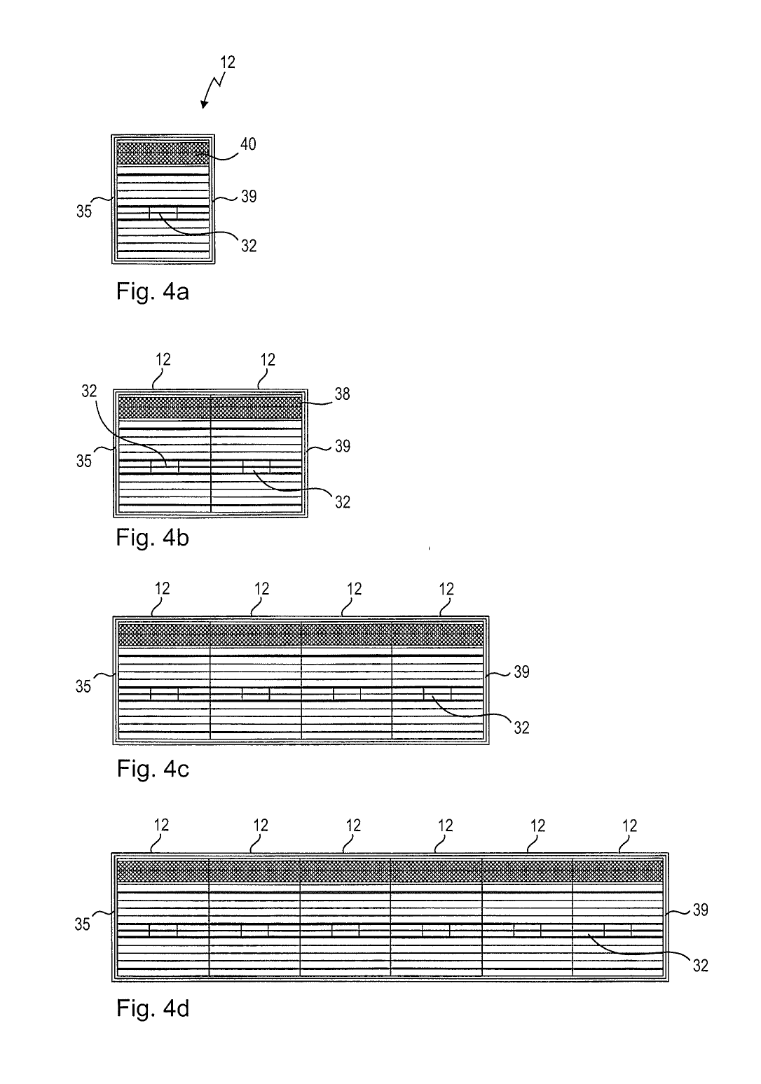

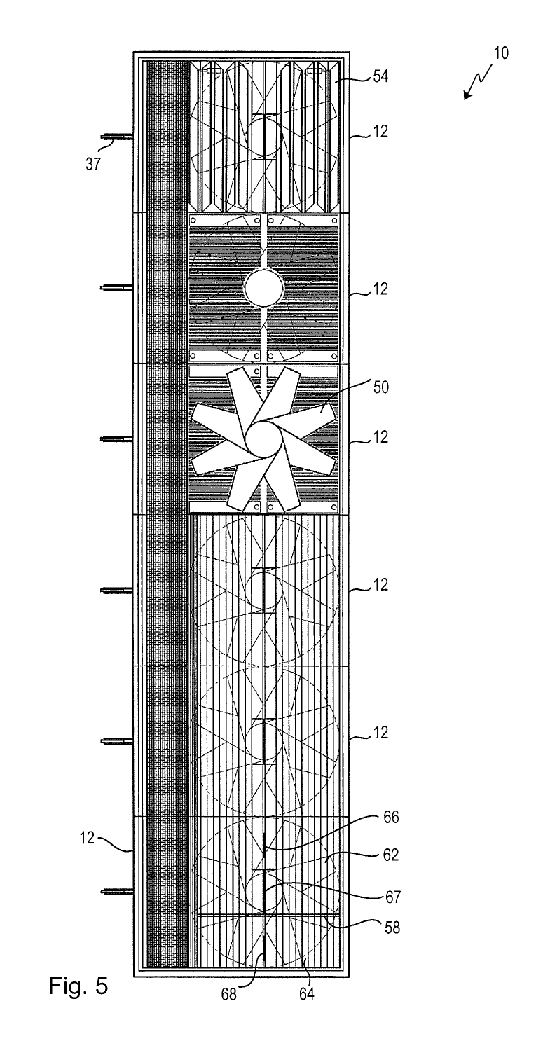

In FIG. 5, the situation as in FIG. 4d is represented once again, somewhat enlarged, wherein, in the, in the representation of FIG. 5, top three performance modules 12, the sections Va to Vb of FIG. 1 are represented.

In the case of the, in FIG. 5, topmost performance module 12, a section just above the bypass valves 54 is shown, in the case of the second performance module 12 from the top a section along the line Vb beneath the axial-flow blower 50, and in the case of the third performance module 12 from the top the section Vc just above the axial-flow blower 50.

In FIG. 5 it can be seen that, in the case of the, in this representation, bottommost performance module 12, a partition 58, which divides the process chamber 18 into two different sub-units 62 and 64, is inserted from above.

The partition 58 is here placed such that it divides the process chamber 18 in the ratio 2:1. That is to say that the smaller sub-unit 64 corresponds to one-third of the original process chamber volume, the sub-unit 62 to approximately two-thirds.

In these sub-units 62 and 64, trials can be conducted on a miniature or laboratory scale if a material is intended to be treated for which the corresponding treatment conditions must first be sought empirically. The previously shown division was in the ratio 2:1; of course, other division criteria, too, can be employed for appropriate preliminary studies.

From the representation of FIG. 5, it can be seen that the linear spray nozzle 32 is divided into three active portions 66, 67 and 68.

If the partition 58 is placed as represented in FIG. 5, then the portion 68 can subject the sub-unit 64 to spraying medium. Accordingly, the two portions 66 and 67 subject the larger sub-unit 62 to spraying medium.

In FIG. 3 it is indicated that between the guide plates 22 and 24 lying one above the other are arranged air guide elements 70.

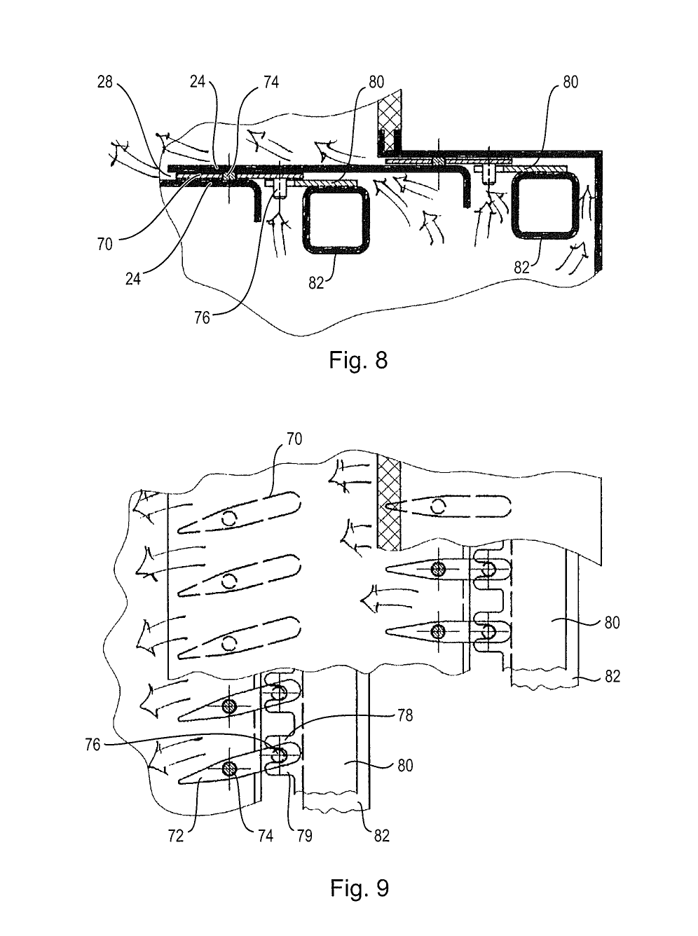

From the enlarged representations of FIGS. 8 to 11, it can be gleaned that each air guide element 70 consists of one guide finger 72, which is rotatably mounted via an upright bearing pin 74 extending between two overlapping guide plates 24. This bearing pin 74 can at the same time also serve as a spacer between two guide plates 24 placed one above the other.

On the bottom side of each guide finger 72 protrudes a stay bolt 76, which is accommodated between two teeth 78 and 79 of a combing plate 80. The combing plate 80 itself is connected to an actuating rod 82.

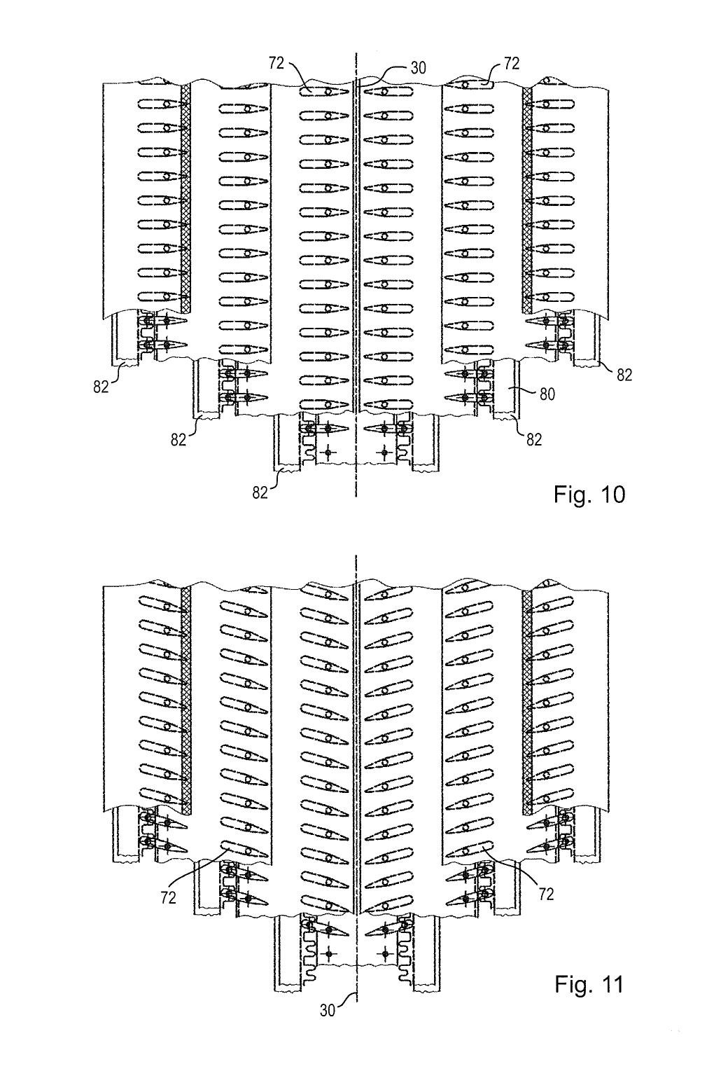

In FIG. 10 is represented a situation in which the actuating rod 82 has displaced the combing plate 80 into such a position that all the guide fingers 72 stand exactly at right angles to the breaking up zone 30 or to the appropriate linear spray nozzle 32. In this case, no motion components in the direction of the breaking up zone 30 or in the direction of the longitudinal extent of the linear spray nozzle 32 would be imposed upon the two opposing partial currents by the guide fingers 72. In the adjustment position represented in FIG. 11, the guide fingers 72 would impose upon the partial currents feeding opposingly onto the breaking up zone 30 respectively a motion component in the same direction, in the representation of FIG. 11 downwards. This can be utilized, for instance, to empty the apparatus, made up of a plurality of joined-together performance modules 12, at one end.

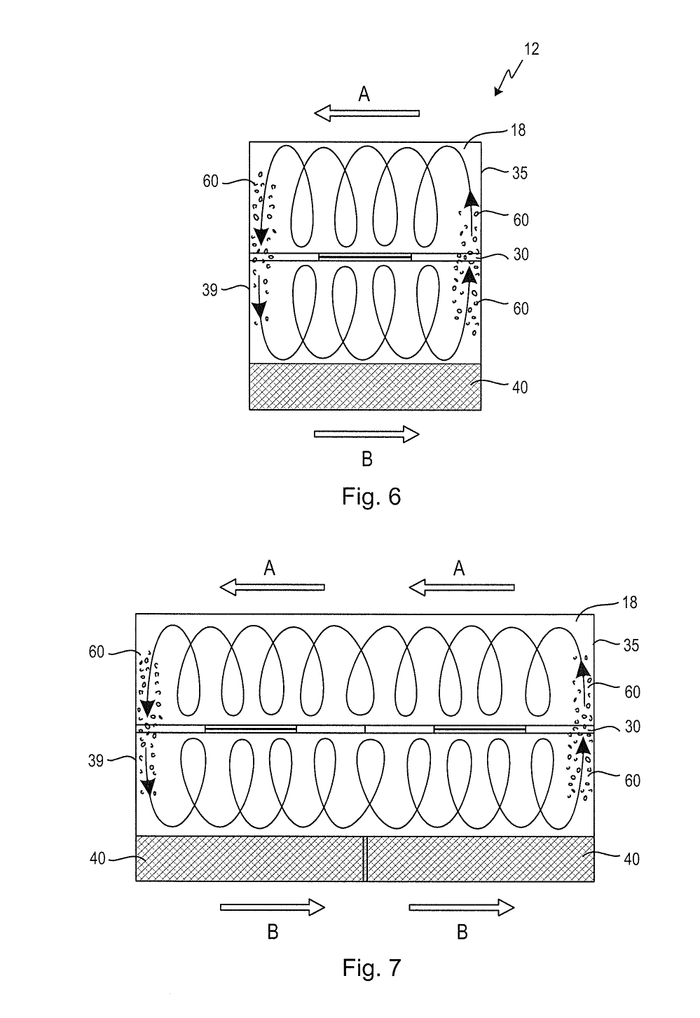

In FIG. 3 is represented that the air guide elements 70 and the corresponding guide fingers 72 are set such that they impose a motion component upon the opposing currents, which motion components, viewed in the longitudinal direction of the breaking up zone 30, are opposite in nature. The result of this is represented in FIGS. 6 and 7. In FIG. 6, a top view of a bottom 20 of a performance module 12 is shown in heavily schematic representation, as is shown in FIG. 3, yet merely rotated through 90°.

As previously mentioned, on one side of the breaking up zone 30 a motion component in the direction A is imposed upon the inflowing process air 29.

On the opposite side, the guide fingers 72 are oriented such that a motion component along the breaking up zone 30 in the opposite direction B is imposed upon the process air 29.

The result of this is that, as a result of the motion component in the direction B, at the right-hand end the material particles 60 are compacted somewhat, since, due to the side wall 35, they are no longer moved onward, so that these are moved over the breaking up zone 30 in the direction of the other half.

There, in the region of the side wall 35, as a result of the oppositely directed motion component A, a certain paucity of material particles 60 has been produced, so that these are sucked up here and moved in the direction of the opposite side wall 39, where they are again compacted somewhat. There, they then pass again over the breaking up zone 30 into the impoverished region having the motion component B. This motion component is superimposed, of course, upon the vertically upward rising and laterally falling motion component, as is represented in FIG. 2.

Viewed overall, there thus results in a performance module 12 a circulating motion component along the arrows A and B and along the inner side of the side walls 35 and 39.

These motion components ensure a certain mixture of the material particles 60 in the process chamber 18 of a performance module 12 and contribute to a uniform treatment result.

In FIG. 7, it is now represented that this is also the result when a plurality of performance modules 12, in this case two performance modules 12, are lined up.

From FIG. 7, it is evident that, as a result of the previously described guide fingers 72, on one side of the breaking up zone 30 the motion components B and on the opposite side the motion components A predominate. From here, the material particles 60 are then respectively guided to the one end of the process chamber 18, compacted there, then run over the breaking up zone 30, and are subsequently moved in the opposite direction again in the other half along the motion component A. This is the result if the guide fingers 72, as represented in FIG. 3, are oriented appropriately.

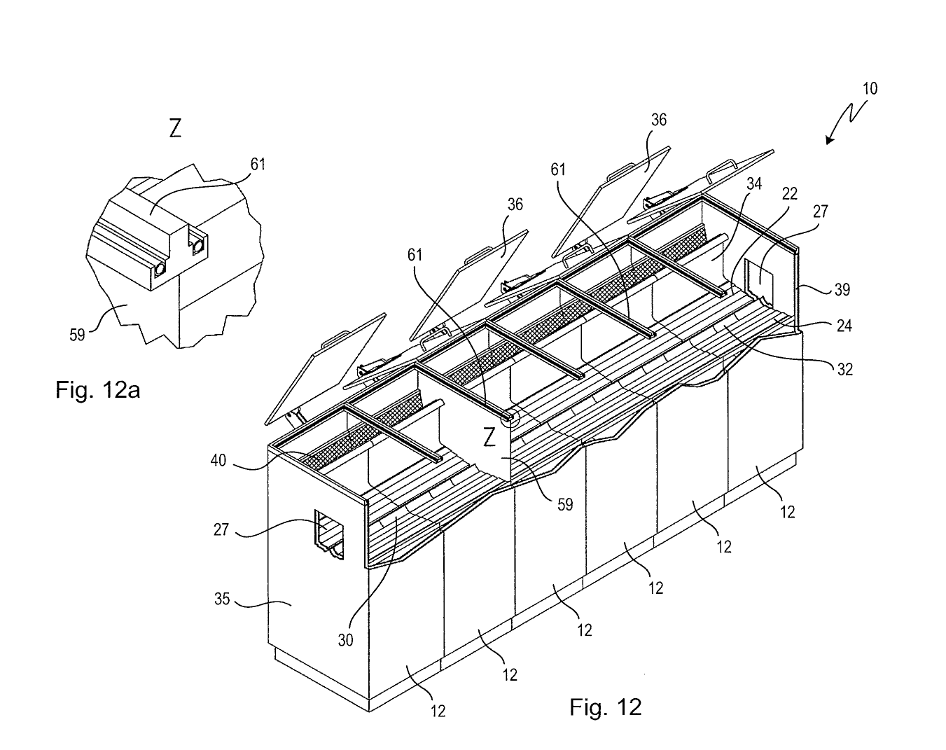

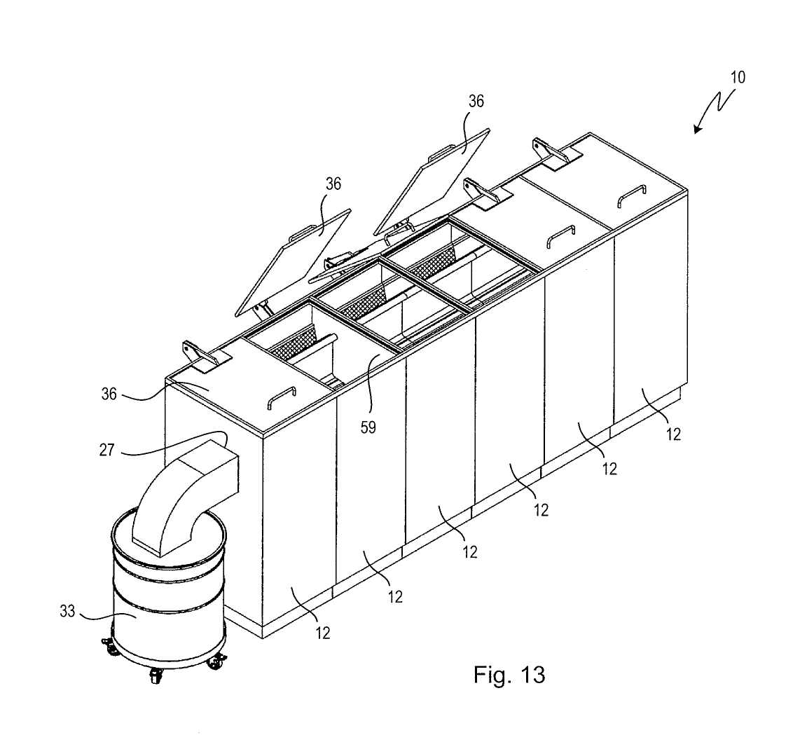

In FIGS. 12 and 13, an apparatus 10, composed of six performance modules 12 in total, is represented in perspective view. From FIG. 12 it is evident that between the second and third aligned performance modules 12 is inserted a partition 59, which divides the entire process chamber 18 into two sub-units, a sub-unit composed of two combined performance modules 12 and a sub-unit composed of four combined performance modules 12.

As can be seen from the enlarged representation of FIG. 12a, the partition 59 is a simple separating plate, which at the upper end is provided with a moulding 61. The moulding 61 is present in any event, for it serves as a bearing surface for the adjacent lids 36 of the second and third performance module 12. That is to say, where necessary the partition 59 can easily be inserted from below into the moulding 61 and held by the latter. This demonstrates how, by relatively flexible means, a high flexibility to process chamber sizes of different volume can be acquired.

From the perspective representation of FIG. 12, it is evident that at the front and/or rear end of the apparatus 10, in the corresponding wall 35 and 39 of the respective performance module 12, is provided an opening 27, via which the interior can be emptied. To this end, as is represented in FIG. 13, a so-called emptying barrel 33 is connected, into which the treated material can be emptied after a treatment process. In order to empty the entire material specifically in this direction, the air guide elements 70 or the guide fingers 72 are oriented such as is represented in FIG. 11, that is to say that a motion component is imposed upon the material, which motion component moves the latter in the direction of the emptying barrel 33.

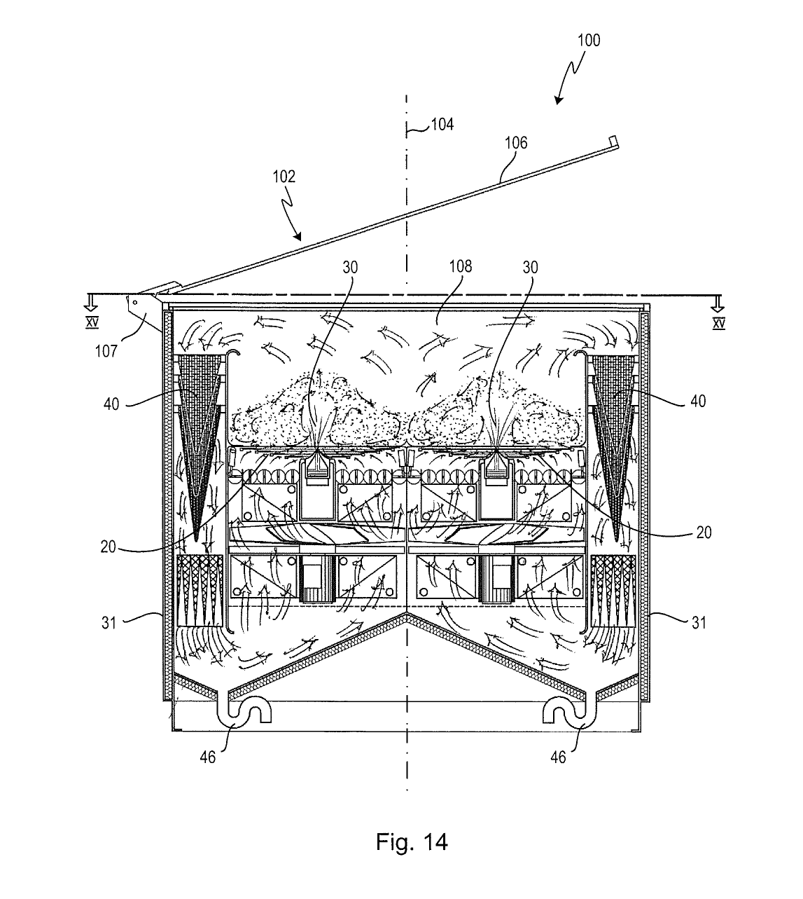

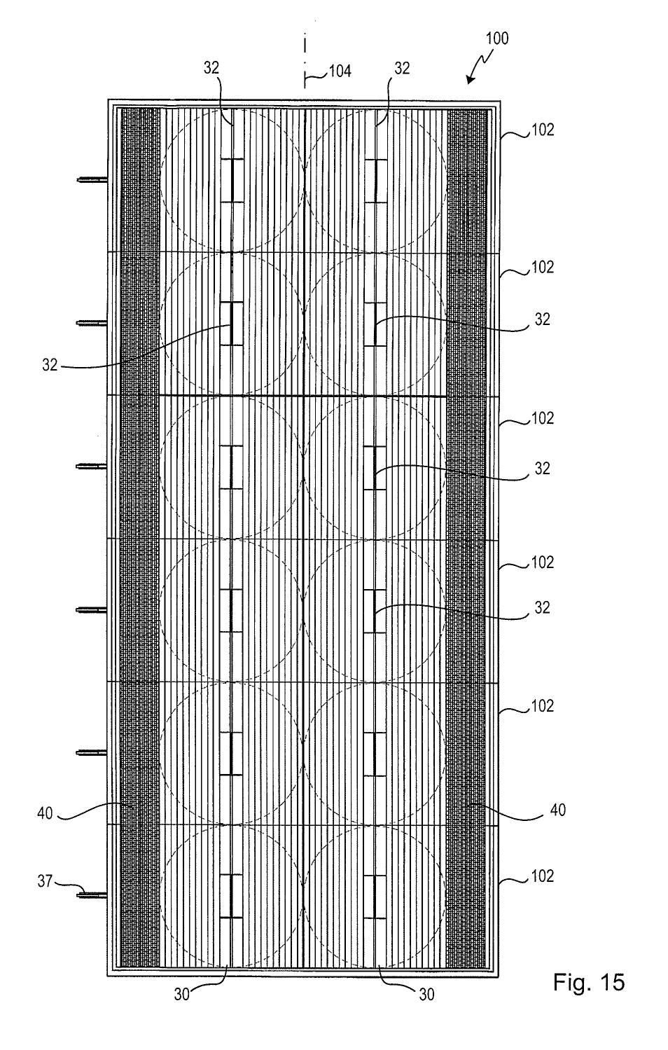

In FIGS. 14 and 15, it can be seen that, in the case of the apparatus 100, the basic module is a double performance module 102.

If the performance module 12 of FIG. 1 is compared with the double performance module 102, then it becomes immediately evident that the double performance module 102 is assembled from two performance modules 12, which are combined in mirror image to a mirror plane 104 and in which the face wall 25 is omitted.

The double performance module 102 thus has on the outer sides lying opposite the mirror plane 104 the appropriate filters 40 and, correspondingly, two adjoining floors 20, which are at the same level. Thus two breaking up zones 30 also exist, which are arranged, however, in a common process chamber 108.

The lid 106 is then configured such that it covers the interior of the double performance module 102. In FIG. 14, it is thus evident that the first or initial double performance module 102 is composed of two performance modules 12, which are arranged in mirror image to one another and which, as regards the basic component parts, are of same construction as the performance module 12. Same reference symbols have therefore been used also for comparable component parts.

From FIG. 15 it can be gleaned that six such double performance modules 102 are arranged one against the other in a row, so that the two parallelly running breaking up zones 30 extend in the longitudinal direction and direction of alignment respectively. Accordingly, the linear spray nozzles 32 disposed in this region are also arranged in a double row, one behind the other. In this embodiment, already in the double performance module 102, approximately twice the quantity as in the performance, module 12 can then be treated. Accordingly, in the overall plant represented in FIG. 13 and consisting of six double performance modules 112, twelve times the quantity can be treated.

What is claimed is:

1. An apparatus for treating a particulate material,
said apparatus being composed of joined individual performance modules,
each of said performance modules being of approximately same construction type and same size,
each of said performance modules comprises a housing having a horizontal rectangular cross section with upstanding side wall parts,
each performance module being able to be joined to another performance module via at least one open side wall part,
each of said individual performance modules comprise a
process chamber having a bottom constructed from overlapping guide plates, between which gaps are present through which a process air can be introduced approximately horizontally into said process chamber,
said overlapping guide plates being arranged in that two flows of said process air of opposite flowing direction can be formed when process air being introduced, said two opposite flows of said process air meet along a linear breaking up zone and are deflected upwardly in said process chamber,
at least one spray nozzle being arranged in said breaking up zone for spraying a treatment medium onto a material moving upwardly in said breaking up zone,
wherein said individual performance modules are joined together to a now in an orientation that said linear breaking up zones of said bottoms of said joined performance modules extend in a same direction and in a direction of said row.

2. The apparatus of claim 1, wherein each performance module is provided with an own blower, by which said process air can be introduced into said process chamber through said gaps between said horizontal plates.

3. The apparatus of claim 2, wherein said blower is constructed as an axial-flow-blower having a fan, said fan being arranged beneath said bottom of said individual performance module.

4. The apparatus of claim 1, wherein each performance module is provided with a movable lid, which constitutes an upper end of said process chamber.

5. The apparatus of claim 4, wherein each of said performance modules is provided with a filter arrangement, said filter arrangement being arranged on one of said side wall parts which is 90° offset from said open side wall part.

6. The apparatus of claim 5, wherein process air flowing upwardly in said process chamber is diverted by said lid laterally and downwardly directed into said filter arrangement.

7. The apparatus of claim 1, where each of that performance modules being provided with a heat exchanger arranged under said bottom.

8. The apparatus of claim 1, wherein said spray nozzle arranged along said breaking up zone is a linear spray nozzle which sprays vertically upwards.

9. The apparatus of claim 1, wherein a partition can be inserted between two adjacent performance modules which partition splits said joined together performance modules into sub-units of performance modules.

10. The apparatus of claim 1, wherein at least one wall can be inserted into an individual performance module, which wall subdivides said process chamber of said individual performance module into at least two sub-process chambers.

11. The apparatus of claim 10 wherein said spray nozzle has individual spray sections allowing to supply said sub process chambers with said treatment medium.

12. The apparatus of claim 1, wherein two performance modules are combined to a double performance module, said two performance modules are combined along open side wall parts thereof which are 90° offset to said at least one open side wall part for joining to a next performance module of said row.

13. The apparatus of claim 12, wherein each of said two performance modules are provided with a filter arrangement arranged on one side wall part thereof, said filter arrangements are arranged on opposite side wall parts of the resulting double performance module, said opposite side wall parts extend transversely to said direction of said row.

14. The apparatus of claim 1, wherein each of said performance modules have a process chamber of approximately square cross section and wherein said breaking up zone runs centrally in said process chamber.

15. The apparatus of claim 14, wherein a process chamber of an individual performance module has a cross sectional width within a range from 300 to 700 mm and can be filled to a static product fill height in a range from 100 to 150 mm.

16. The apparatus of claim 15, wherein said process chamber has a cross sectional width within a range from 400 to 600 mm and a static product fill height from 110 to 140 mm.

17. The apparatus of claim 16, wherein said process chamber has a cross sectional width of approximately 500 mm and a static product fill height of about 135 mm.

18. The apparatus of claim 11, wherein said spray nozzle is a linear spray nozzle having spray-active longitudinal portion of 50 to 100 mm.

19. The apparatus of claim 1, wherein air guide elements are arranged in said bottom, which air guide elements impose upon said process air flowing through said bottom, on both sides of that breaking up zone, a motion component in said direction of said row of joined performance modules.

20. The apparatus of claim 19, wherein said air guide elements are adjustable, so that a variable motion component in said direction of said row can be imposed upon to said process air.

21. The apparatus of claim 20, wherein said air guide elements are adjustable in such a way that on one side of said breaking up zone a motion component in one direction of said row can be imposed upon the process air, whilst on another side of said breaking up zone a motion component can be imposed on the opposite direction.

22. The apparatus of claim 21, wherein said air guide elements are configured as guide fingers arranged between said overlapping guide plates, and wherein said air guide elements are pivotable about a vertical axis, which guide fingers are all connected to a common actuating element, a displacement of said actuation element causes a common pivoting of said guide fingers.

23. The apparatus of claim 21, wherein said air guide elements on one side of said breaking up zone are adjustable independently from said air guide elements of an opposite side of that breaking up zone.

24. The apparatus of claim 23, wherein said adjustable air guide elements are provided with a control mechanism, each control mechanism can couple to another when joining tow adjacent performance modules.
